(19) United States
(12) Patent Application Publication
(10) Pub. No.: US 2015/0070347 A1
(43) Pub. Date: Mar. 12, 2015

(54) COMPUTER-VISION BASED AUGMENTED REALITY SYSTEM

(71) Applicants: Klaus Michael Hofmann, Amsterdam (NL); Ronald Van Der Lingen, Delft (NL)

(72) Inventors: Klaus Michael Hofmann, Amsterdam (NL); Ronald Van Der Lingen, Delft (NL)

(73) Assignee: Layar B.V., Amsterdam (NL)

(21) Appl. No.: 14/239,190

(22) PCT Filed: Aug. 18, 2011
(86) PCT No.: PCT/EP2011/064252

§ 371 Date: Oct. 17, 2014

(51) Int. Cl. G06T 19/00; G06F 3/0481

(52) U.S. Cl. CPC G06T 19/006; G06F 3/04815; G06T 2219/024
USPC 345/419

(57) ABSTRACT

Methods for providing a graphical user interface through an augmented reality service provisioning system. A panel is used as a template to enable content providers to provide configurations for a customizable graphical user interface. The graphical user interface is displayable in perspective with objects in augmented reality through the use of computer vision techniques.

### CROSS-REFERENCE TO RELATED APPLICATION

This application is a Section 371 National Stage Application of International Application PCT/EP2011/064252 filed Aug. 18, 2011 and published as WO 2013/023706 A1 in English, which is related to co-pending to an International (Patent Cooperation Treaty) Patent Application No. PCT/EP2011/064251, filed on Aug. 18, 2011, entitled “Methods and Systems for Enabling Creation of Augmented Reality Content” which application is incorporated herein by reference and made a part hereof in its entirety.

### FIELD OF INVENTION

The disclosure generally relates to a system for enabling the generation of a graphical user interface (GUI) in augmented reality. In particular, though not necessarily, the disclosure relates to methods and systems facilitating the provisioning of features and the retrieval of content for use as a graphical user interface in an augmented reality (AR) service provisioning system.

### BACKGROUND

The discussion below is merely provided for general background information and is not intended to be used as an aid in determining the scope of the claimed subject matter.

Due to the increasing capabilities of multimedia equipment mobile augmented reality (AR) applications are rapidly expanding. These AR applications allow augmentation of a real scene with additional content, which may be displayed to a user on the display of an AR device in the form of a graphical layer overlaying the real-word scenery. The first systems hosting such mobile AR services are set up and rapidly grow in popularity. One key feature for rapid adoption by users is the use of an open architecture wherein standardized procedures allow users and content providers to design their own augmented content and to offer this content to users of the platform.

It is known that AR applications may include computer vision techniques, e.g. markerless recognition of objects in an image, tracking the location of a recognized object in the image and augmenting the tracked object with a piece of content by e.g. mapping the content on the tracked object. Simon et. al have shown in their article “Markerless tracking using planer structures in the scene” in: Symposium on Augmented Reality, October 2000. (ISAR 2000), p. 120-128, that such markerless tracking system for mapping a piece of content onto a tracked object may be built.

One of the problems is that although implementation of such markerless augmented reality services may greatly enhance the AR user experience, such techniques to enable such services are still relatively complex. For that reason, an open platform supporting a scalable solution for markerless augmented reality services on mobile AR devices is still lacking.

A further problem relates to the fact that when mapping a piece of content onto a tracked object, the content will be transformed (i.e. translated, rotated, scaled) so that it matches the 3D pose of the tracked object. In that case, when the 3D matched content is part of (or configured as) a graphical user interface (GUI), user-interaction with the content becomes more difficult. Hence, when implementing markerless augmented reality services, efficient and simple user-interaction with the content should be preserved.

Hence, it is desirable to provide an AR platform, which allows easy implementable image processing functionality, including image recognition and tracking functionality. In particular, it is desired to provide an AR platform, preferably an open AR platform, allowing the use of a standardized data structure template for rendering content on the basis of computer vision functionality and for facilitating and managing user interaction with the thus rendered and displayed content.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

This disclosure describes improved methods and systems that enable the generation of a graphical user interface for use in an augmented reality system. The improved GUI represents interactive computer generated graphics that are positioned in close relation to an object of interest as seen by a user. The relationship between the real world object of interest and the interactive computer generated graphics is visual (i.e., they appear to be physically related to each other). The interactivity may enable a user to discover further related content associated with the object of interest. As described herein, content generally refers to any or combination of: text, image, audio, video, animation, or any suitable digital multimedia output.

To enable a content provider to easily make use of the augmented reality system, a panel data structure is used to allow the content provider to define/configure the graphical user interface. In general, a particular panel data structure is associated with a particular real world object to be recognized and tracked in the augmented reality system by an object descriptor. For instance, each panel may be associated with a unique object ID. A panel allows a content provider to associate a particular real world object with an interactive graphical user interface. Said interactive graphical user interface is to be displayed in perspective with the object as seen by the user through an augmented reality system. The panel enables the augmented reality service provisioning system to provide related content and enhanced graphical user interfaces to the user, once the object has been recognized in a camera image frame, in a customizable manner for the content provider.

In one aspect, the disclosure relates to a method for generating an augmented reality content item on a user device comprising a digital imaging part, a display output, a user input part and an augmented reality client, said client comprising a computer-vision based tracker for tracking an object in said display on the basis of at least an image of the object from the digital imaging part, said method comprising: receiving an object identifier associated with an object in an image, preferably said object identifier being generated by an object recognition system; on the basis of said object identifier retrieving panel data from a panel database and tracking resources from a tracking resources database, said panel data comprising at least location information for retrieving a content item; on the basis of said tracking resources said computer-vision based tracker generating three-dimensional pose information associated with said object; on the basis of said panel data requesting at least part of said content item; and, on the basis of said three-dimensional pose information rendering said content item for display in the display output such that the content rendered matches the three-dimensional pose of said object in the display output.

In another aspect, the disclosure relates to a method for generating an augmented reality graphical user interface on a user device comprising a digital imaging part, a display output, a user input part and an augmented reality client, said client comprising a computer-vision based tracker for tracking an object in said display on the basis of at least an image of the object from the digital imaging part, said method comprising: receiving an object identifier associated with an object in an image, preferably said object identifier being generated by an object recognition system; on the basis of said object identifier retrieving panel data from a panel database and tracking resources from a tracking resources database, said panel data comprising at least location information for retrieving a content item and user interactivity configuration information, said content item and said user interactivity information defining a graphical user interface; on the basis of said tracking resources said computer-vision based tracker generating three-dimensional pose information associated with said object; on the basis of said panel data, requesting at least part of said content item; and, on the basis of said user interactivity configuration information and said three-dimensional pose information, rendering said graphical user interface for display in the display output such that the graphical user interface rendered matches the three-dimensional pose of said object in the display output.

In one embodiment, the method may further comprise: receiving an image frame from a digital imaging device of the augmented reality system; transmitting the image frame to an object recognition system; receiving, in response to transmitting the image frame, identification information for the tracked object from an object recognition system if the transmitted image frame matches the tracked object; and storing the identification information for the tracked object as state data in the tracker.

In an embodiment, the method may further comprise: receiving, at the tracker, an image frame from a camera of the augmented reality system; estimating, in the tracker, the three-dimensional pose of the tracked object from at least the image frame; and storing the estimated three-dimensional pose of the tracked object as state data in the tracker.

In another embodiment estimating the three-dimensional pose of the tracked object from at least the image frame may comprise: obtaining reference features from a reference features database based on the identification information in the state data; extracting candidate features from the image frame; searching for a match between the candidate features and reference features, said reference features associated with the tracked object in the image frame; estimating a two-dimensional translation of the tracked object in the image frame in response to a finding a match from searching for the match between candidate and reference features; estimating a three-dimensional pose of the tracked object in the image frame based at least in part on the camera parameters and the estimated two-dimensional translation of the tracked object.

In a further embodiment said three-dimensional pose information may be generated using homogeneous transformation matrix H and a homogeneous camera projection matrix P, said homogeneous transformation matrix H comprising rotation and translation information associated with the camera relative to the object and said homogeneous camera projection matrix defining the relation between the coordinates associated with the three-dimensional world and the two-dimensional image coordinates.

In another embodiment said content layout data may comprise visual attributes for elements of the graphical user interface.

In yet another embodiment the user interactivity configuration data may comprise at least one user input event variable and at least one function defining an action to be performed responsive to a value of the user input event variable.

In a further embodiment, the method may further comprise: receiving a first user input interacting with the graphical user interface; retrieving a further content item on the basis of said location information in said panel data, said further content item and said user interactivity configuration information defining a further graphical user interface; on the basis of said user interactivity configuration information and said three-dimensional pose information, rendering said further graphical user interface for display in the display output such that the graphical user interface rendered matches the three-dimensional pose of said object in the display output.

In one variant, said three-dimensional pose information is generated using a homogeneous transformation matrix H, said homogeneous transformation matrix H comprising rotation and translation information of the camera relative to the object, wherein said method may further comprise: receiving a first user input interacting with said graphical user interface for generating a further graphical user interface; providing a second homogeneous transformation matrix H′ only comprising a static translation component; generating further three-dimensional pose information on the bases of said second homogeneous transformation matrix H′; on the basis of said user interactivity configuration information and said further three-dimensional pose information, rendering said further graphical user interface for display in the display output such that said further graphical user interface rendered is detached from the three-dimensional pose of said object in the display output and positioned at a fixed distance behind the camera.

In another variant said panel data further may comprise: content layout information for specifying the display of a subset of content items from a plurality of content items in a predetermined spatial arrangement, preferably in a linear arrangement, in said display output; user interactivity configuration information comprises a function for displaying a next subset of content items from said plurality of images in response to receiving a first user input interacting; and location information comprising instructions for fetching at least one additional content items of said next subset of content items from a location wherein the method may further comprise: on the basis of said content layout information, said user interactivity configuration information, said location information and said three-dimensional pose information, rendering a further graphical user interface for display in the display output such that said further graphical user interface rendered matches the three-dimensional pose of said object in the display output.

In yet a further variant said panel data may further comprise: the user interactivity configuration information comprises a function for displaying at least part of the backside of an augmented reality content item or an augmented reality graphical user interface in response to receiving a first user input interacting; location information comprising instructions for fetching a further content item and/or a further graphical user interface associated with the backside of said augmented reality content item or said augmented reality graphical user interface; wherein said method may further comprise: on the basis of said content layout information, said user interactivity configuration information, said location information and said three-dimensional pose information, rendering a further graphical user interface for display in the display output such that said further graphical user interface rendered matches the three-dimensional pose of said object in the display output.

In a further variant said panel database and said tracking resources database may be hosted on one or more servers, and said augmented reality client may be configured to communicate with said one or more servers.

In another aspect the disclosure may relate to a client for generating an augmented reality content item on a user device comprising a digital imaging part, a display output, a user input part, said client comprising a computer-vision based tracker for tracking an object in said display on the basis of at least an image of the object from the digital imaging part, said being configured for: receiving an object identifier associated with an object in an image, preferably said object identifier being generated by an object recognition system; on the basis of said object identifier retrieving panel data from a panel database and tracking resources from a tracking resources database, said panel data comprising at least location information for retrieving a content item; on the basis of said tracking resources said computer-vision based tracker generating three-dimensional pose information associated with said object; on the basis of said panel data requesting at least part of said content item; and, on the basis of said three-dimensional pose information rendering said content item for display in the display output such that the content rendered matches the three-dimensional pose of said object in the display output.

In yet another aspect the disclosure may relate to a client for generating an augmented reality graphical user interface on a user device comprising a digital imaging part, a display output, a user input part, said client comprising a computer-vision based tracker for tracking an object in said display on the basis of at least an image of the object from the digital imaging part, said client further being configured for: receiving an object identifier associated with an object in an image, preferably said object identifier being generated by an object recognition system; on the basis of said object identifier retrieving panel data from a panel database and tracking resources from a tracking resources database, said panel data comprising at least location information for retrieving a content item and user interactivity configuration information, said content item and said user interactivity information defining a graphical user interface; on the basis of said tracking resources said computer-vision based tracker generating three-dimensional pose information associated with said object; on the basis of said panel data, requesting at least part of said content item; and, on the basis of said user interactivity configuration information and said three-dimensional pose information, rendering said graphical user interface for display in the display output such that the graphical user interface rendered matches the three-dimensional pose of said object in the display output.

In yet a further aspect, the disclosure relates to a user device comprising a client as described above, and a vision-based augmented reality system comprising at least one of such user devices and one or more servers hosting a panel database, a tracking resources database and a object recognition system.

The disclosure further relates to a graphical user interface for a user device comprising a digital imaging part, a display output, a user input part and an augmented reality client, said graphical user interface being associated with a object displayed in said display output; said graphical user interface being rendered on the basis of panel data from a panel database and three-dimensional pose information associated with said object, said panel data comprising at least location information for retrieving a content item,

wherein said graphical user interface comprises said content item and at least one user input area, wherein said content item and said at least one user input area match the three-dimensional pose of said object.

The disclosure also relates to a computer program product, implemented on computer-readable non-transitory storage medium, the computer program product configured for, when run on a computer, executing the method steps as described above.

Aspects of the invention will be further illustrated with reference to the attached drawings, which schematically show embodiments. It will be understood that the invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 depicts a vision-based AR system according to one embodiment of the disclosure;

FIG. 2 depicts at least part of a vision-based AR system according to a further embodiment of the disclosure;

FIG. 3 depicts a panel data structure according to an embodiment of the disclosure;

FIG. 4 depicts at least part of a data structure for a tracking resource according to one embodiment of the disclosure;

FIG. 5 depicts an object recognition system according to one embodiment of the disclosure;

FIG. 6 depicts at least part of a tracking system for use in a vision-based AR system according to one embodiment of the disclosure;

FIG. 7 depicts an AR engine for use in a vision-based AR system according to one embodiment of the disclosure;

FIG. 8 depicts a system for managing panels and tracking resources according to one embodiment of the disclosure;

FIGS. 9A and 9B depict graphical user interfaces for use in a vision-based AR system according to various embodiments of the disclosure;

FIG. 10 depict graphical user interfaces for use in a vision-based AR system according to further embodiments of the disclosure; and

FIG. 11 depict graphical user interfaces for use in a vision-based AR system according to yet even further embodiments of the disclosure.

### DETAILED DESCRIPTION OF THE ILLUSTRATIVE EMBODIMENTS

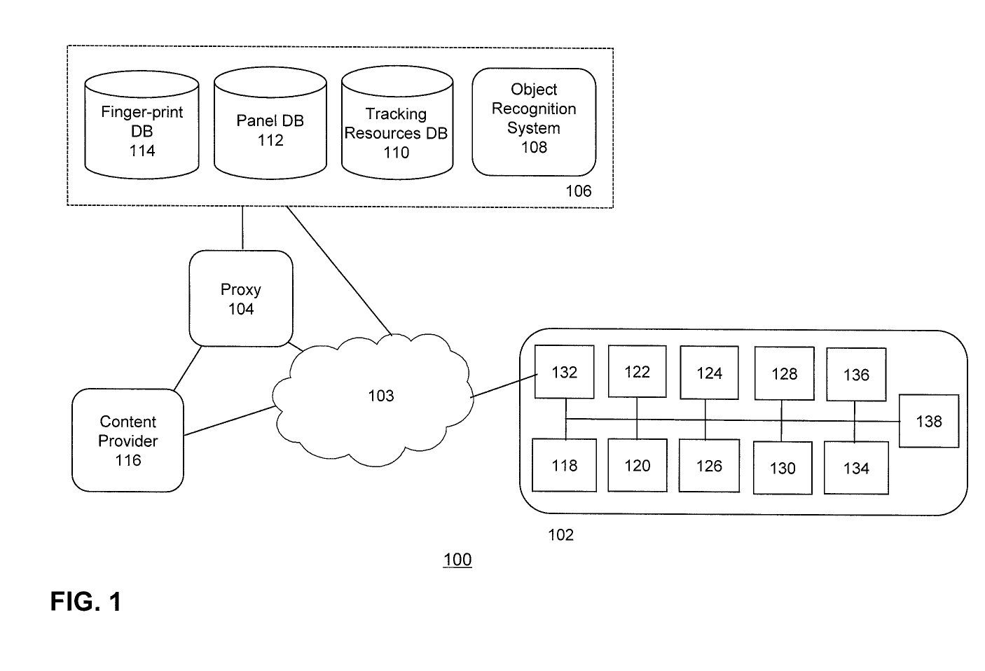

FIG. 1 depicts a vision-based AR system 100 according to one embodiment of the disclosure. The system comprises one or more AR devices 102 communicably connected via an access network 103 and an (optional) proxy server 104 to an augmented reality (AR) content retrieval system 106 comprising at least an object recognition system 108, a tracking resources database 110, a panel database 112 and a fingerprint database 114.

The proxy server may be associated with an AR service provider and configured to relay, modify, receive and/or transmit requests sent from communication module 106 of AR device, to the AR content retrieval system. In some embodiments, AR device may directly communicate the AR content retrieval system.

An AR device may be communicably connected to one or more content providers 116 to retrieve content needed for generating a graphical overlay in the graphics display.

An AR client 118 running on AR device is configured to generate an AR camera view by displaying a graphical overlay in display 120 over the camera feed of the mobile device provided by digital imaging device 122. In some embodiments, the AR client may configure parts of the graphical overlay as a graphical user interface (GUI). A GUI may be defined as an object within a software environment providing an augmented reality experience and allowing a user to interact with the AR device. The graphical overlay may comprise content which is provided by one of the content providers (e.g., content provider 116). The content in the graphical overlay may depend on the objects in the display.

A user may utilize a user interface (UI) device 124 to interact with a GUI provided in the camera view. User interface device(s) may include a keypad, touch screen, microphone, mouse, keyboard, tactile glove, motion sensor or motion sensitive camera, light-sensitive device, camera, or any suitable user input devices. In some embodiments, digital imaging device may be used as part of a user interface based on computer vision (e.g. capabilities to detect hand gestures).

The AR client may start with a content retrieval procedure when a user points the camera towards a particular (real) object, so that AR client may receive an image frame or a sequence of image frames comprising the object from the digital imaging device. These image frames may be sent to the object recognition system 108 for image processing. Object recognition system may comprise an image detection function, which is capable of recognizing particular object(s) in an image frame. If one or more objects are recognized by the object recognition system it may return an object descriptor (e.g., object identifier or “object ID”) of the recognized object(s) to the AR client.

On the basis of the object descriptor, the AR client may retrieve so-called tracking resources and a panel associated with the recognized object from the AR content retrieval system. To that end, the AR client may query the tracking resources and panel database associated with the AR content retrieval system on the basis of the object descriptor. Alternatively, the object recognition system may query the tracking resources and panel database directly and forward, the thus obtained object descriptor, tracking resources and panel to the AR client.

The tracking resources associated with an object descriptor may allow a tracker function in AR client to track the recognized object in frames generated by the camera of the AR device. The tracking resources enable a tracker in the AR device to determine the three-dimensional (3D) pose of an object in the images generated by the digital imaging device.

A panel associated with an object descriptor may allow the AR client to generate a graphical overlay displayable in perspective with a tracked object. A panel may be associated with a certain data structure, preferably a data file identified by a file name and a certain file name extension. A panel may comprise content layout information, configuration information for configuring user-interaction functions associated a GUI, and content location information (e.g. one or more URLs) for fetching content, which is used by the AR client to build the graphical overlay. The tracking resources and panel associated with an object descriptor will be described hereunder in more detail.

On the basis of the information in the panel, the AR client may request content from a content provider 116 and render the content into a graphical overlay using the content layout information in the panel. The term content provider may refer to an entity interested in providing related content for objects recognized/tracked in the augmented reality environment. Those entities may include people or organizations interested in providing content to augmented reality users. The content may include text, video, audio, animations, or any suitable multimedia content for user consumption.

The AR client may be further configured to determine the current 3D object pose (e.g., position and orientation of the tracked object in 3D space) and to reshape the graphical overlay and to display the reshaped these overlays over or in conjunction with the tracked object. The AR client may constantly update the 3D object pose. Hence, when the user moves the camera, the AR client may update the 3D object pose on the basis of a further image frame and use the updated 3D object pose to reshape the graphical overlay and to correctly align it with the tracked object. Details about the processes for generating the graphical overlay and, when configured as part of a GUI, interacting with the graphical overlay on the basis of information in the panel will be described hereunder in more detail.

Typically, an AR device may comprise at least one of a display 120, a data processor 126, an AR client 118, an operating system 128, memory 130, a communication module 132 for (wireless) communication with the AR content retrieval system, various sensors, including a magnetometer 134, accelerometer 136, positioning device 138 and/or a digital imaging device 122. A sensor API (not shown) may collect sensor data generated by the sensors and sent the data the AR client. The components may be implemented as part of one physical unit, or may be distributed in various locations in space as separate parts of the AR device.

Display 120 may be an output device for presentation of information in visual form such as a screen of a mobile device. In some embodiments, a display for a spatial augmented reality system may be a projection of visual information onto real world objects. In some other embodiments, a display for a head-mounted augmented reality system may be optically projected into the eyes of a user through a virtual retinal display. Display may be combined with UI 124 to provide a touch-sensitive display.

Processor 126 may be a microprocessor configured to perform computations required for carrying the functions of AR device. In some embodiments, the processor may include a graphics processing unit specialized for rendering and generating computer-generated graphics. The processor may be configured to communicate via a communication bus with other components of AR device

An implementation of AR client 118 may be a software package configured to run on AR device, which is configured to provide a camera view where a user may view the real world through a display, whereby the processor combines an optically acquired image from the digital imaging device and computer generated graphics from processor to generate an augmented reality camera view.

AR device may have operating system 128 installed or configured to run with processor. Operating system may be configured to manage processes running on processor, as well as facilitate various data coming to and from various components of AR device. Memory may be any physical, non-transitory storage medium configured to store data for AR device. For example, memory may store program code and/or values that are accessible by operating system running on processor. Images captured by the digital imaging device may be stored in memory as a camera buffer.

Communication module 132 may include an antenna, Ethernet card, a radio card associated with a known wireless 3G or 4G data protocol, Bluetooth card, or any suitable device for enabling AR device to communicate with other systems or devices communicably connected to a suitable communication network. For instance, communication module may provide internet-based connections between AR device and content provider to retrieve content related to a particular tracked object. In another instance, communication module may enable AR devices to retrieve resources such as tracking resources and panels from tracking resources database and panel database.

Magnetometer 134 (also referred to as magneto-resistive compass or electronic/digital compass) may be an electronic device configured to measure the magnetic field of the Earth, such that a compass reading may be determined. For instance, a mobile phone as AR device may include a built in digital compass for determining the compass heading of AR device. In certain embodiments, the orientation of the user or AR device may be determined in part based on the compass reading. In some embodiments, AR device may include a (e.g., 3-axis) gyroscope, not shown in FIG. 1, to measure tilt in addition to direction heading. Other sensors, not shown in FIG. 1, may include proximity and light sensors.

AR device may include accelerometer 136 to enable an estimate movement, displacement and device orientation of AR device. For instance, accelerometer may assist in measuring the distance travelled by AR device. Accelerometer may be used as means of user input, such as means for detecting a shaking or toss motion applied to AR device. Accelerometer may also be used to determine the orientation of AR device, such as whether it is being held in portrait mode or landscape mode (e.g., for an elongated device). Data from accelerometer may be provided to AR client such that the graphical user interface(s) displayed may be configured according to accelerometer readings.

For instance, a GUI (e.g., such as the layout of the graphical user interface) may be generated differently depending on whether the user is holding a mobile phone (i.e., AR device) in portrait mode or landscape mode. In another instance, a GUI may be dynamically generated based at least in part on the tilt measured by the accelerometer (e.g., for determining device orientation), such that three-dimensional graphics may be rendered differently based on the tilt readings (e.g., for a motion sensitive augmented reality game). In some cases, tilt readings may be determined based on data from at least one of: accelerometer and a gyroscope.

AR device may further include a positioning device 138 configured to estimate the physical position of AR device within a reference system. For instance, positioning device may be part of a global positioning system (GPS), configured to provide an estimate of the longitude and latitude reading of AR device.

In some embodiments, computer-generated graphics in the three-dimensional augmented reality environment may be displayed in perspective (e.g., affixed/snapped onto) with a tracked real world object, even when the augmented reality device is moving around in the augmented reality environment, moving farther away or closer to the real world object.

Sensor data may also be used as user input to interact with the graphical user interfaces displayed in augmented reality. It is understood by one of ordinary skilled in the art that fusion of a plurality of sources of data may be used to provide the augmented reality experience.

In some embodiments proxy server 104, may be further configured to provide other augmented reality services and resources to AR device. For example, the proxy server may enable an AR device to access and retrieve so-called geo-located points of interests for display on the AR device. Examples of such AR services are described in a related co-pending international patent application PCT/EP2011/059155, which is filed on Jun. 1, 2011 and which is hereby incorporated by reference.

It is submitted that the described AR devices may take different forms, and the forms primarily fit into different ways to display the content to a user. A display may be part of a head-mounted device, such as an apparatus for wearing on the head like a pair of glasses. A display may also relate to an optically see-through, while still able to provide computer-generated images by reflective optics. Further, a display may be video see-through where a user's eyes may be viewing stereo images as captured by two cameras on the head-mounted device or a handheld display (such as a emissive display used in e.g. a mobile phone, a camera or handheld computing device). Further types of displays may include a spatial display, where the user actually directly views the scene through his/her own eyes without having to look through glasses or look on a display, and computer generated graphics are projected from other sources onto the scene and objects thereof.

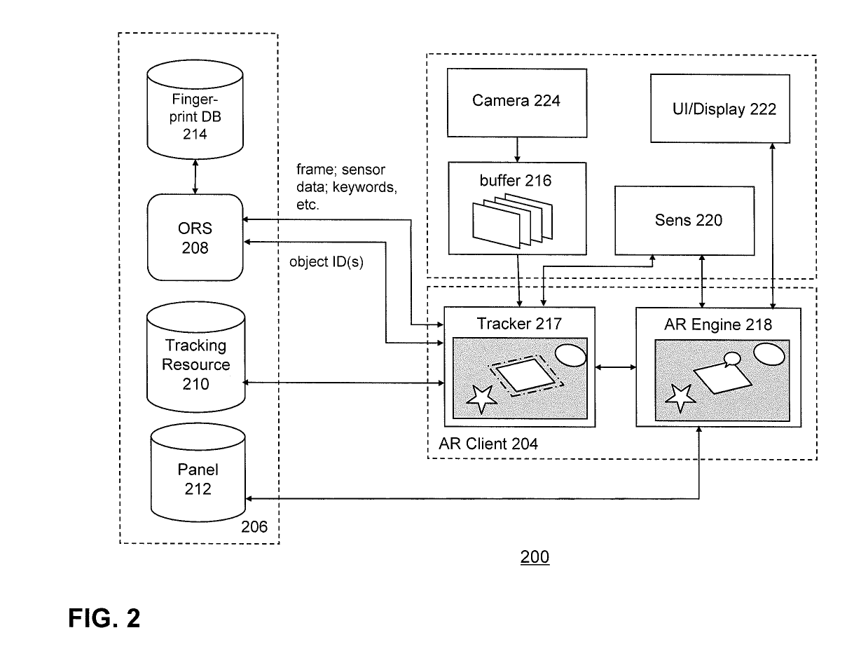

FIG. 2 depicts at least part of a vision-based AR system 200 according to a further embodiment of the disclosure. In particular, in this figure the interaction between the AR content retrieval system 206, an AR client 204 in the AR device and sensor and imaging components of the AR device is illustrated.

To enable object recognition, the fingerprint database 214 comprises at least one fingerprint of the visual appearance of an object. A fingerprint may be generated on the basis of at least one image and any suitable feature extraction methods such as: FAST (Features from Accelerated Segment Test), HIP (Histogrammed Intensity Patches), SIFT (Scale-invariant feature transform), SURF (Speeded Up Robust Feature), BRIEF (Binary Robust Independent Elementary Features), etc.
The fingerprint may be stored in fingerprint database 214, along with other fingerprints. In one embodiment, each fingerprint is associated with an object ID such that a corresponding panel in the panel database may be identified and/or retrieved.

The object recognition system 208 may apply a suitable pattern matching algorithm to identify an unknown object in a candidate image frame, by trying to find a sufficiently good match between the candidate image frame (or extracted features from the candidate image frame) and at least one of the fingerprints in the set of fingerprints stored in fingerprint database 214 (may be referred to as a reference fingerprints). Whether a match is good or not good may be based on a score function defined in the pattern-matching algorithm (e.g., a distance or error algorithm).

The object recognition system 208 may receive a candidate image or a derivation thereof as captured by the camera 224 of the AR device. AR client 204 may send one or more frames (i.e. the candidate image frame) to object recognition system to initiate object recognition.

Once the object recognition algorithm is executed, object recognition system may return results comprising at least one object ID. The returned object ID may correspond to the fingerprint that best matches the real world object captured in the candidate image frame. In the event that no results are found (or that no fingerprint represents a good enough match with the candidate image), a message may be transmitted to AR client to indicate that no viable matches have been found by object recognition system 208.

If at least one object ID is found, the returned object ID(s) are used by tracker 217 to allow AR client 204 to estimate the three-dimensional pose information of the recognized object (i.e., to perform tracking). To enable tracking, tracking resource database 210 may provide the resources needed for tracker to estimate the three-dimensional pose information of a real world object pictured in the image frame.

Tracking resources may be generated by applying a suitable feature extraction method to one or more images of the object of interest. The tracking resources thus comprise a set of features (i.e., tracking resources) to facilitate tracking of the object within in an image frame of the camera feed. The tracking resource is then stored among other tracking resources in tracking resource database 210, which may be indexed by object IDs or any suitable object identifiers.

Hence, when the tracker receives object ID(s) from the ORS, it may use the object ID(s) to query the tracking resources database to retrieve appropriate set of tracking resources for the returned object ID(s). The tracking resources retrieved from tracking resources database enables tracker of AR client to estimate the 3D pose of an object real-time. Tracker may retrieve successively frames from the buffer 216 of image frames. Then a suitable estimation algorithm may be applied by tracker to generate 3D pose estimation information of the tracked object within each of the successive image frames, and updates the data/state according to the estimations. The estimation algorithm may use the retrieved tracking resources, frame and camera parameters in order to generate an estimated 3D pose.

After the estimation algorithm has been executed, tracker provides the three-dimensional pose estimation information to AR engine 218. As such, the pose estimation information may be used to generate a graphical overlay, preferably comprising a GUI, that is displayed in perspective with the tracked object in the image frames.

In some embodiments, the estimated 3D pose information from tracker enables 3D computer generated graphics to be generated (e.g., using AR engine) in perspective with the tracked object. To generate the computer graphics, the respective panel may be retrieved from panel database. For example, AR engine may form a request/query for panel database using the object ID(s) provided by object recognition system, to retrieve the respective panel for the tracked object.

A panel may be used to configure a GUI, which is attached to and in perspective with the 3D pose of the tracked object. Once an object is tracked, the panel may enable a GUI to be generated in AR engine for display through display on the basis of the pose information calculated in tracker.

A user may interact with the GUI via a UI. AR engine, in accordance with the user interactivity configuration in the respective panel, may update the computer-generated graphics and/or interactive graphical user interface based on user input from UI 222 and/or data from sensor 220. For instance, the interactive graphical user interface may be updated once a user presses a button (e.g., hardware or software) to view more related content defined in the panel. In response to the button press, AR client may fetch for the additional related content on the basis of location information, e.g. URLs, in the panel, such that it can be rendered by AR engine. The additional related content may be displayed in accordance with the user interactivity configuration information in the panel and the current tracker state.

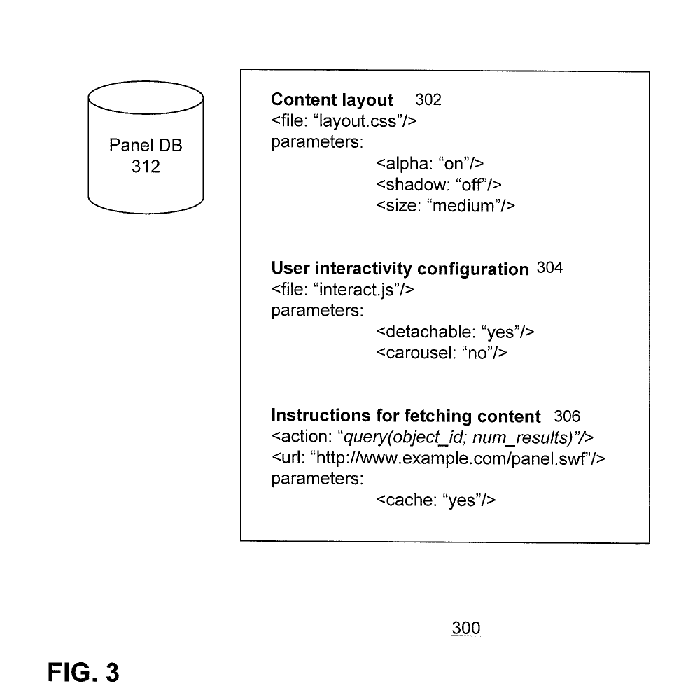

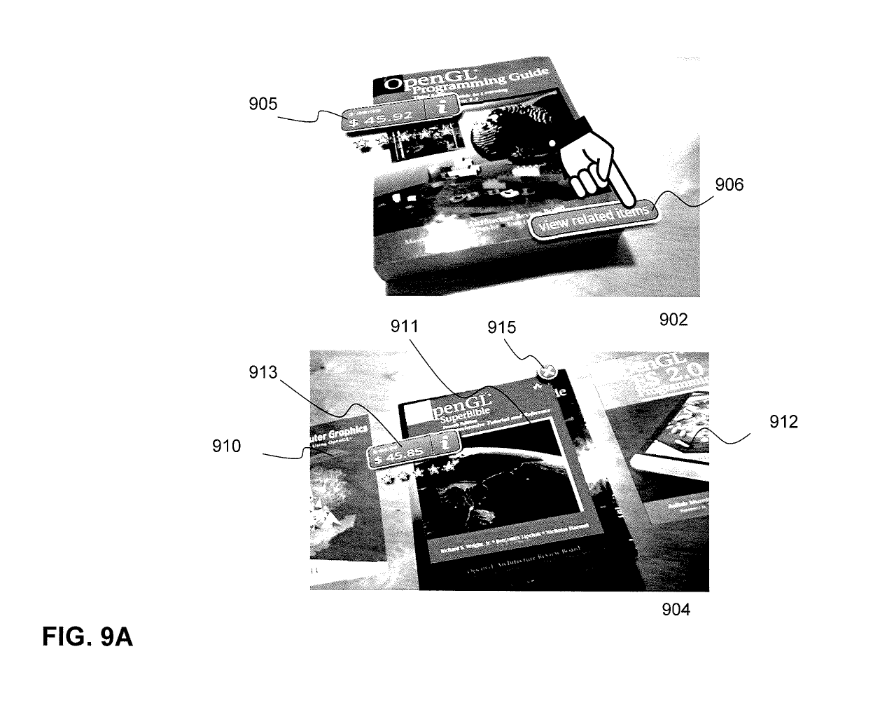

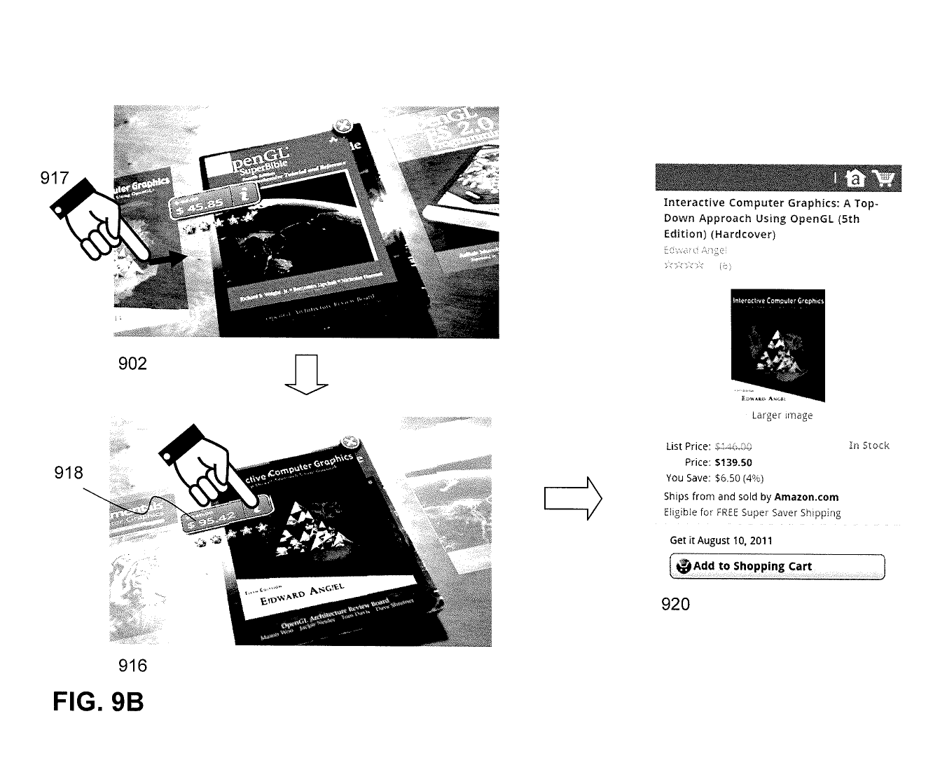

FIG. 3 depicts a panel data structure 300 stored in panel database 312 according to an embodiment of the disclosure. The panel is a data structure comprising at least one of: content layout information 302, user interactivity configuration information 304, and instructions for fetching content 306. In this disclosure, a panel includes an object data structure. The object data structure may include at least one of: identification for the particular object, information related to content layout, user interactivity configuration, and instructions for fetching content. An example of a more complex interactive panel is described hereunder with reference to FIG. 9A and FIG. 9B.

Hereunder a simplified representation in pseudo-code of a panel API is provided. A panel may be defined by a panel definition, describing the overall properties of the panel and the attributes that can be configured and a panel template, which may comprise references to various files (e.g. HTML, SVG, etc.) and links to interactivity definitions (e.g. JavaScript). The example describes a scalable vector graphics (SVG) based non-interactive panel that represents a picture frame. The panel may comprise a panel definition and a panel template. The panel definition may describe the overall properties of the panel and the attributes that can be configured. For example it may contain parameters to specify the size and color of the frame and the image to be shown:

```
{
  panel_definition_id: 123,
  panel_developer: developername,
  template_url: http://example.com/panel_template.svg
  attributes: [
    {
      type: float,
      name: width
    },
    {
      type: float,
      name: height
    }
    {
      type: color,
      name: color
    },
    {
      type: imageurl,
      name: contents
    }
  ]
}
```

Further, the panel template may comprise references to various files (e.g. HTML, SVG, etc.):

```
Panel template (panel_template.svg):
<svg>
  <image width=“%width%” height=“%height%”
src=“%contents%”/>
  <rect width=“%width%” heigth=“%height%” stroke=“%color%”
fill=“none”/>
</svg>
```

Here panel instances may be represented as follows:

```
{
  panel_id: 456,
  panel_definition_id: 123,
  attribute_values: {
    width: 640,
    height: 480,
    color: #ff0000,
    contents: http://example.com/images/photo.jpg
  },
  placement: {
    object_id: 789,
    offset: {
      x: 100, y: 200, z: 0
    },
    angle: 45,
  }
}
```

Hence, in the example above, a panel is defined which is associated with object descriptor 789 and uses content for the graphical overlay which is stored at http://example.com/images/photo.jpg and which is displayed in accordance with the size and color and vector information (x,y,z,angle) for placement of the generated graphics layer comprising a content item or a GUI with respect to the tracked object. If all values are zero, the graphics layer is aligned with the center of the tracked object. The coordinates may be defined in absolute values or as a percentage of the with/height of the tracked object.

In this example, the attribute values are substituted in the template by replacing the placeholders % attributename % with the given value. In case of an interactive panel however the panel template may also comprise interactivity components, e.g. links to interactivity definitions (e.g. JavaScript).

When having an interactivity component however, the attribute values cannot be simply added by simple substitution as described above. In that case, it should be ensured that the interactivity components are processed on the basis of the correct parameters. For example, in case of an HTML panel template with a Javascript based interactivity component, the Javascript may have a method for injecting the attribute values into the code like this:

```
template.js:
function setAttributes(attributes) {
  // read text from attributes and set a value in the HTML
  document.getElementById(“textfield”).innerHTML =
attributes.text;
}
```

As a GUI includes at least one graphical or visual element. These elements may include text, background, tables, containers, images, videos, animations, three-dimensional objects, etc. The panel may be configured to control how those visual elements are displayed, how users may interact with those visual elements, and how to obtain the needed content for those visual elements.

A panel may allow a user, in particular a content provider to easily configure and control a particular GUI associated with a real world object. In some embodiments, a panel is associated with a real world object by an object descriptor (e.g., object ID).

A panel may include some content, typically static and small in terms of resources. For instance, a panel may include a short description (e.g., a text string of no more than 200 characters). Some panels may include a small graphic icon (e.g., an icon of 50×50 pixels). Further, a panel may include pointers to where the resource intensive or dynamic content can be fetched. For instance, a panel may include a URL to a YouTube video, or a URL to a server for retrieving items from a news feed. In this manner, resource intensive and/or dynamic content is obtained separately from the retrieval of panels for a particular tracked object. The design of the panel enables the architecture to be more scalable as the amount of content and the number of content provider grows.

Content layout may include information for specifying the look and feel (i.e., presentation semantics) of the interactive graphical user interface. The information may be defined in a file whereby a file path or URL may be provided in the panel to allow the AR client to locate the content layout information. Exemplary content layout information may include a varied combination of variables and parameters, including:
specification for margin, border, padding and/or position of elements,
specification for color, transparency, alpha channel value, size, shadows and/or for various elements,
font properties
text attributes such as direction, spacing between words, letters, and lines of text,
alignment of elements, etc.

User interactivity configuration information may comprise functions for defining actions that are executed in response to certain values of variables. The functions may be specified or defined in a file whereby a file path or URL may be provided in the panel to allow the AR client to locate the user interactivity configuration.

For instance, in one embodiment those functions may execute certain actions in response to a change in the state of the AR client application. The state may be dependent on the values of variables of the AR client or operating system of the AR device. In another instance, those functions may execute certain actions in response to user input. Those functions may check or detect certain user input signals (e.g., from camera, one of the sensors, and/or UI) or patterns from those signals.

In another embodiment those functions may check for or detect user input such as such as button clicks, cursor movement, or gestures. Illustrative user interactivity configuration information may include a function to change the color of a visual element in response to a user pressing on that visual element. Another illustrative user interactivity configuration may include a function to play a video if a user has been viewing the interactive graphical user interface for more than 5 seconds.

User interactivity configuration information for some panels may comprise parameters for controlling certain interactive features of the GUI (e.g., on/of setting for playing sound, on/off setting for detachability, whether playback is allowed on video, to display or not display advertisements, on/of setting for availability of certain interactive features, etc.) or for executing more advanced content rendering applications like the “image carrousel” API as described in more detail with reference to FIGS. 9A and 9B.

Instructions for fetching content comprises information for obtaining resource intensive and/or dynamic/live content. Instructions may include a URL for locating and retrieving the content (e.g., a URL for an image, a webpage, a video, etc.) or instructions to retrieve a URL for locating and retrieving content (e.g., a DNS request) Instructions may include a query for a database or a request to a server to retrieve certain content (e.g., an SQL query on an SQL web server, a link to a resource on a server, location of an RSS feed, etc.).

Hence, from the above it follows that a panel may provide different levels of freedom for controlling, configuring and displaying AR content associated with a tracked object. A panel allows a simple and flexible way of defining GUIs associated with tracked objects with a minimum amount of knowledge about computer vision techniques. It provides the advantage of abstracting the complexities of computer vision/graphics programming from the content provider, while still allowing access to the AR services and resources for the content provider to provide related content in the augmented reality environment. Moreover, panel templates may be defined providing pre-defined GUIs, wherein a user only has to fill in certain information: e.g. color and size parameters and location information, e.g. URLs, where content is stored.

Once the panel is fetched and the pose information is determined, an AR engine of the AR client can generate an interactive graphical user interface using the panel information and the pose information. Said interactive graphical user interface would then be displayed in perspective with the recognized real world item within the augmented reality environment (i.e., a three-dimensional augmented reality space). Visually, the GUI interface would be displayed in perspective with the object even when the object/user moves within the augmented reality environment.

Panels allows the AR content retrieval system to be scalable because it provides a platform for content to be hosted by various content providers. For content-based applications, scalability is an issue because the amount of content grows quickly with the number of content providers. Managing a large amount of content is costly and unwieldy. Solutions where almost all of the available content being stored and maintained in a centralized point or locally on an augmented reality device is less desirable than solutions where content is distributed over a network, because the former is not scalable.

In an illustrative example, related items for purchase are displayed in the augmented reality environment in perspective with a tracked object in a scene. The related content is preferably dynamic, changing based on factors such as time, the identity of the user, or any suitable factors, etc. Examples of dynamic content may include content news feeds or stock quotes. Moreover, an augmented reality service provider may not be the entity responsible for managing the related content. Preferably, the content available through the augmented reality service provisioning system is hosted in a decentralized manner by the various content providers, such that the system is scalable to accommodate the growth of the number of content providers.

In some embodiments, the use of a “panel” as an application programming interface enables content providers to provide information associated with certain objects to be recognized/tracked, such as content layout, user interactivity configuration, instructions for fetching related content, etc. A panel may provide constructs, variables, parameters and/or built in functions that allow content providers to utilize the augmented reality environment to define the interactive graphical user interfaces associated with certain objects.

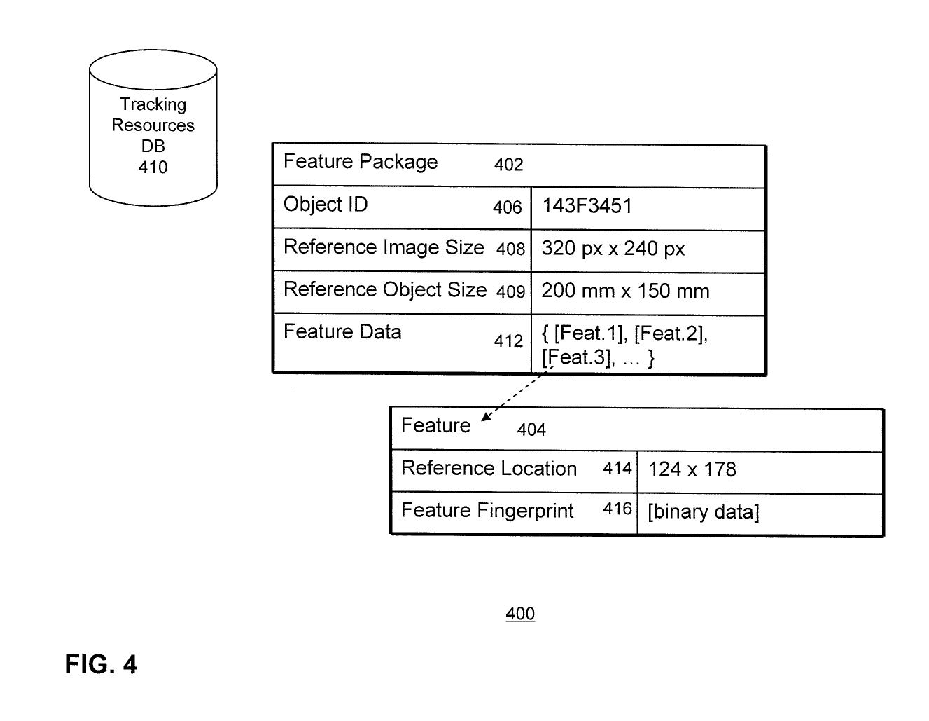

FIG. 4 depicts at least part of a data structure 400 for a tracking resource according to one embodiment of the disclosure. Tracking resources database 410 may store tracking resources (e.g., sets of features) that enables a tracker to effectively estimate the 3D pose of a tracked object. A tracking resource is associated with each tracked object, and is preferably stored in a relational database or the like in tracking resources database 410. In some embodiments, a tracking resource for a particular tracked object may include a feature package (e.g., feature package 402) and at least one reference to a feature (e.g., feature 404). Feature package may include an object ID 406 for uniquely identifying the tracked object. Feature package may further include data for the reference image associated with the tracked object, such as data related to reference image size 408 (e.g., in pixels) and/or reference object size 409 (e.g., in mm).

Feature package may include feature data 412. Feature data may be stored in a list structure of a plurality of features. Each feature may include information identifying the location of a particular feature in the reference image in pixels 414. Feature package may include a binary feature fingerprint 416 that may be used in the feature matching process.

As will be described below in more detail, in operation, a feature extractor may be used to extract candidate features from a frame. Using these exemplary feature package 402 and feature 404 as reference features, candidate features extracted by feature extractor may be matched/compared with reference features to determine whether the tracked object is in the frame (or in view).

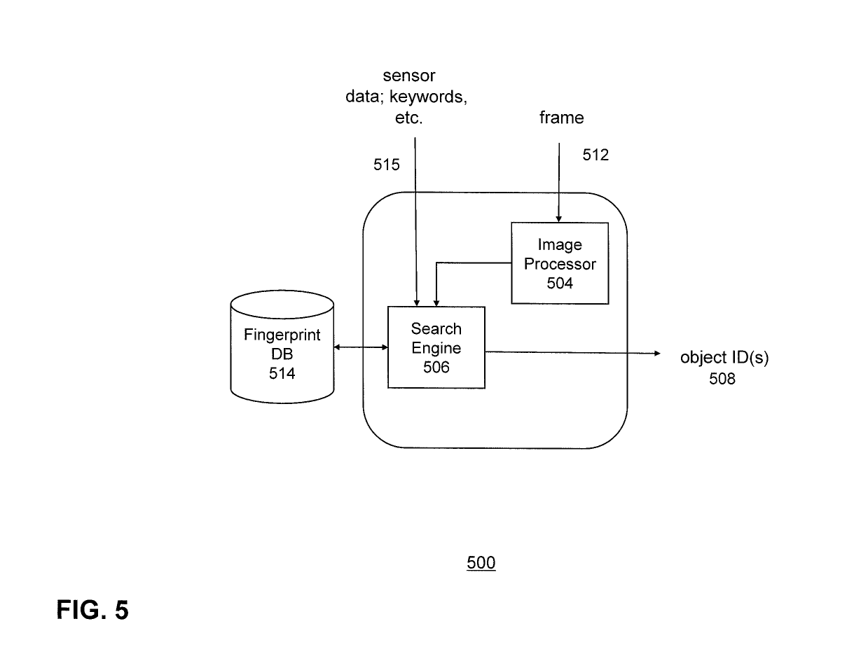

FIG. 5 depicts an object recognition system 500 according to one embodiment of the disclosure. Object recognition system 500 is used to determine whether an incoming candidate image frame 502 contains a recognizable object (e.g. a building, poster, car, person, shoe, artificial marker, etc. in the image frame). The incoming candidate image frame is provided to image processor 504. Image processor 504 may process the incoming candidate frame to create feature data including fingerprints that may be easily used in search engine 506. In some embodiments, more than one image (such as a plurality of successive images) may be used as candidate image frames for purposes of object recognition.

Depending on how fingerprints in fingerprint database 514 has been generated, algorithms in image processor 504 may differ from one variant to another. Image processor 504 may apply an appearance/based method, such as edge detection, color matching, etc. Image processor 504 may apply feature-based methods, such as scale-invariant feature transforms, etc. After the incoming candidate frame has been processed, it is used by search engine 506 to determine whether the processed frame matches well with any of the fingerprints in fingerprint database 514. Optionally, sensor data and keywords 515 may be used as a heuristic to narrow the search for matching fingerprints.

For instance, AR client may provide a keyword based on a known context. In one illustrative example, an AR client may provide a word “real estate” to allow the search engine to focus its search on “real estate” fingerprints. In another illustrative example, AR client may provide the geographical location (e.g., longitude/latitude reading) to search engine to only search for fingerprints associated with a particular geographical area. In yet another illustrative example, AR client may provide identification of a particular content provider, such as the company name/ID of the particular content provider, so that only those fingerprints associated with the content provider is searched and returned.

The search algorithm used may include a score function, which allows search engine 506 to measure how well the processed frame matches a given fingerprint. The score function may include an error or distance function, allowing the search algorithm to determine how closely the processed frame matches a given fingerprint. Search engine 506, based on the results of the search algorithm, may return zero, one, or more than one search results. The search results may be a set of object ID(s) 508, or any suitable identification data that identifies the object in the candidate frame. In some embodiments, if object recognition system has access to tracking resources database and/or panel database (see e.g. FIGS. 1 and 2), tracking resource and panel corresponding to the object ID(s) in the search results may also be retrieved and returned to AR client.

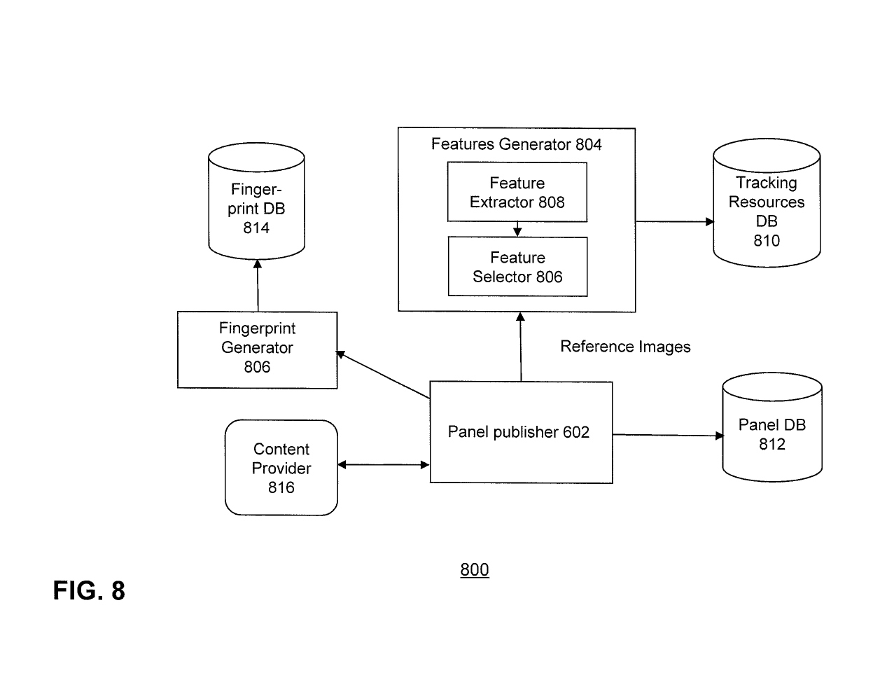

If no matches are found, the search engine may transmit a message to AR client to indicate that no match has been found, and optionally provide object IDs that may be related to keywords or sensor data that was provided to object recognition system. In some embodiments, AR client may be configured to “tag” the incoming image frame such that object recognition system may “learn” a new object. The AR client may for example may start a process for creating a new panel as well as an appropriate fingerprint and tracking resources. A system for creating a new panel is described hereunder in more detail with reference to FIG. 8.

Object recognition is a relatively time and resource consuming process, especially when the size of searchable fingerprints in fingerprint database grows. Preferably, object recognition system is executed upon a specific request from AR client. For instance, the incoming candidate image frame is only transmitted to object recognition system upon a user indicating that he/she would like to have an object recognized by the system.

Alternatively, other triggers such as a location trigger may initiate the object recognition process. Depending on the speed of object recognition system, it is understood that the object recognition may occur “live” or “real time”. For example, a stream of incoming image candidate frames may be provided to object recognition system when an AR client is in “object recognition mode”.

A user may be moving about with the augmented reality device to discover whether there are any recognizable objects surrounding the user. In some embodiments, the visual search for a particular object (involving image processing) may even be eliminated if the location is used to identify which objects may be in the vicinity of the user. In other words, object recognition merely involves searching for objects having a location near the user, and returning the tracking resources associated with those objects to AR client.

Rather than implementing object recognition algorithms locally on the AR device, object recognition may be performed in part remotely by a vendor or remote server. By performing object recognition remotely, AR device can save on resources needed to implement a large-scale object recognition system. This platform feature is particularly advantageous when the processing and storage power is limited on small mobile devices. Furthermore, this platform feature enables a small AR device to access a large amount of recognizable objects.

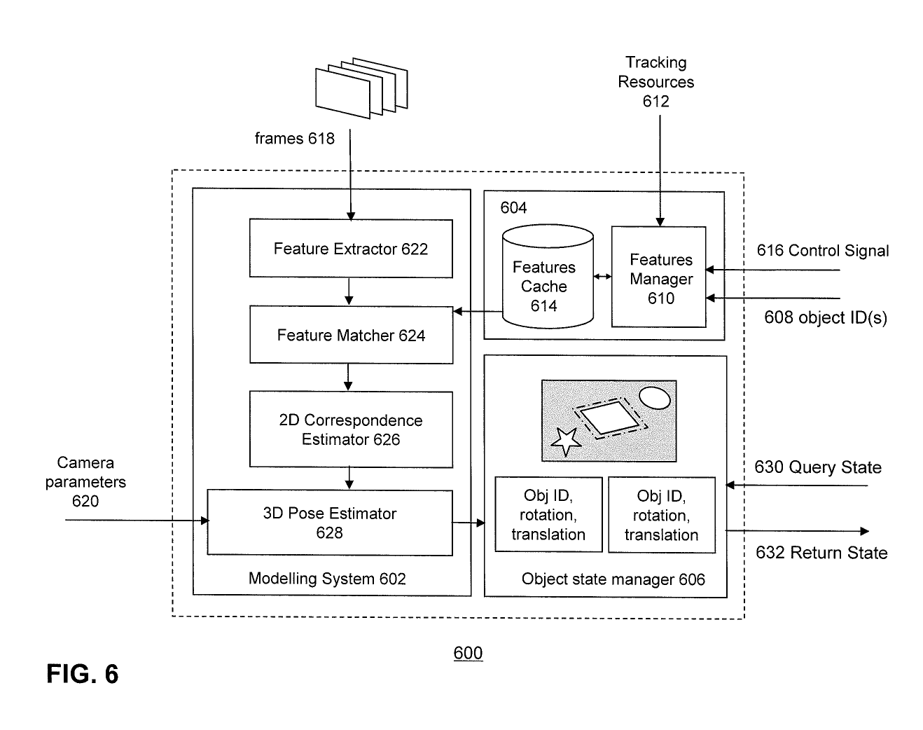

FIG. 6 depicts at least part of a tracking system 600 for use in a vision-based AR system according to one embodiment of the disclosure. The tracking system may include a modeling system 602, a feature manager system 604 and a object state manager 606.

Once the AR client has received object ID(s) 608 from object recognition system, a features manager 610 may request tracking resources 612 from tracking resources DB and stores these tracking resources in a feature cache 614. Exemplary tracking resources may include a feature package for a particular object.

In other variants, the tracker may fetch tracking resources corresponding to the input object ID(s) from tracking resources database, in response to control signal 610. For instance, AR engine may transmit a control signal and object ID(s) from object recognition system to the tracker to initiate the tracking process. In some embodiments, control signal 616 may request the features manager to clear or flush features cache. Further, the control signal may request features manager to begin or stop tracking.

Preferably, tracker runs “real time” or “live” such that a user using the augmented reality system has the experience that the computer-generated graphics would continue to be displayed in perspective with the tracked object as the user is moving about the augmented reality environment and the real world. Accordingly, tracker is provided with successive image frames 618 for processing. In some embodiments, camera parameters 620 may also provided to the tracker.

The modeling system 602 is configured to estimate 3D pose of a real-world object of interest (i.e., the real world object corresponding to an object ID, as recognized by the object recognition system) within the augmented reality environment. The modeling system may use a coordinate system for describing the 3D space of the augmented reality environment. By estimating the three-dimensional pose of the real-world, graphical content and/or GUIs may be placed in perspective with a real world object seen through the camera view.

Successive image frames 618 may be provided to modelling system 602 for processing and the camera parameters may facilitate pose estimation. In this disclosure, a pose corresponds to the combination of rotation and translation of an object in 3D space relative to the camera position.

An image frame may serve as an input to feature extractor 622 which may extract candidate features from the image frame. Feature extractor may apply known feature extraction algorithms such as: FAST (Features from Accelerated Segment Test), HIP (Histogrammed Intensity Patches), SIFT (Scale-invariant feature transform), SURF (Speeded Up Robust Feature), BRIEF (Binary Robust Independent Elementary Features), etc.

The candidate features are then provided to feature matcher 624 with reference features from feature package(s) in features cache 614. A matching algorithm is performed to compare candidate features with reference features. If a successful match has been found, the features providing a successful match are sent to the 2D correspondence estimator 626. The 2D correspondence estimator may then provide an estimation of the boundaries of the object in the image frame

In some embodiments, if there are more than one object being tracked in a scene, then two-dimensional correspondence estimator may produce more than one two-dimensional transformations, one transformation corresponding to each object being tracked.

Two-dimensional correspondence estimator may provide an estimation of the position of the boundaries of the object in the image frame. In some embodiments, if there are more than one object being tracked in a scene, then two-dimensional correspondence estimator may produce more than one two-dimensional transformations, one transformation corresponding to each object being tracked.

Position information of the boundaries of the object in the image frame as determined by the 2D correspondence estimator is then forwarded to a 3D pose estimator 628, which is configured to determine the so-called model view matrix H comprising information about the rotation and translation of the camera relative to the object and which is used by the AR client to display content in perspective (i.e. in 3D space) with the tracked object.

To that end, the 3D pose estimator uses the relation

x=P*H*X

where X is a 4-dimensional vector representing the 3-dimensional object position vector in homogeneous coordinates, H is the 4×4 homogeneous transformation matrix (or model view matrix), P is the 3×4 homogeneous camera projection matrix (which is a function of the focal length f and the resolution of the camera sensor), and x is a 3-dimensional vector representing the 2-dimensional image position vector in homogeneous coordinates. The model view matrix H contains information about the rotation and translation of the camera relative to the object (transformation parameters), while the projection matrix P specifies the projection of 3D world coordinates to 2D image coordinates. Both matrices are specified as homogeneous 4×4 matrices, as used by the rendering framework based on the known OpenGL standard.

On the basis of the camera parameters 620, the 3D pose estimator first determines the camera projection matrix P. Then, on the basis of P and the position information of the boundaries of the object in the image frame as determined by the 2D correspondence estimator, the 3D pose estimator may estimate the rotation and translation entries of H using a non-linear optimization procedure, e.g. the Levenberg-Marquardt algorithm.

The model view matrix is updated for every frame so that the displayed content is matched with the 3D pose of the tracked object.

The rotation and translation information associated with the model view matrix H is subsequently forwarded to the object state manager 606. For each tracked object identified by an object ID, the rotation and translation information is stored and constantly updated by new information received from the 3D pose estimator. The object state manager may receive a request 630 for 3D state information associated with a particular object ID and respond 632 to those requests by sending the requested 3D state information.

Understandably, the process of tracking an object in a sequence of image frames is relatively computationally intensive, so heuristics may be used to decrease the amount of resources to locate an object in the augmented reality environment. In some embodiments, the amount of processing in tracker by reducing the size of the image to be searched in feature matcher 624. For instance, if the object was found at a particular position of the image frame, the feature matcher may begin searching around the particular position for the next frame.

In one embodiment, instead of looking at particular positions of the image first, the image to be searched is examined in multiple scales (e.g. original scale & once down-sampled by factor of 2, and so on). Preferably, the algorithm may choose to first look at the scale that yielded the result in the last frame. Interpolation may also be used to facilitate tracking, using sensor data from one or more sensors in the AR device. For example, if a sensor detects/estimates that AR device has moved a particular distance between frames, the three-dimensional pose of the tracked object may be interpolated without having to perform feature matching. In some situations, interpolation may be used as a way to compensate for failed feature matching frames such that a secondary search for the tracked object may be performed (i.e., as a backup strategy).

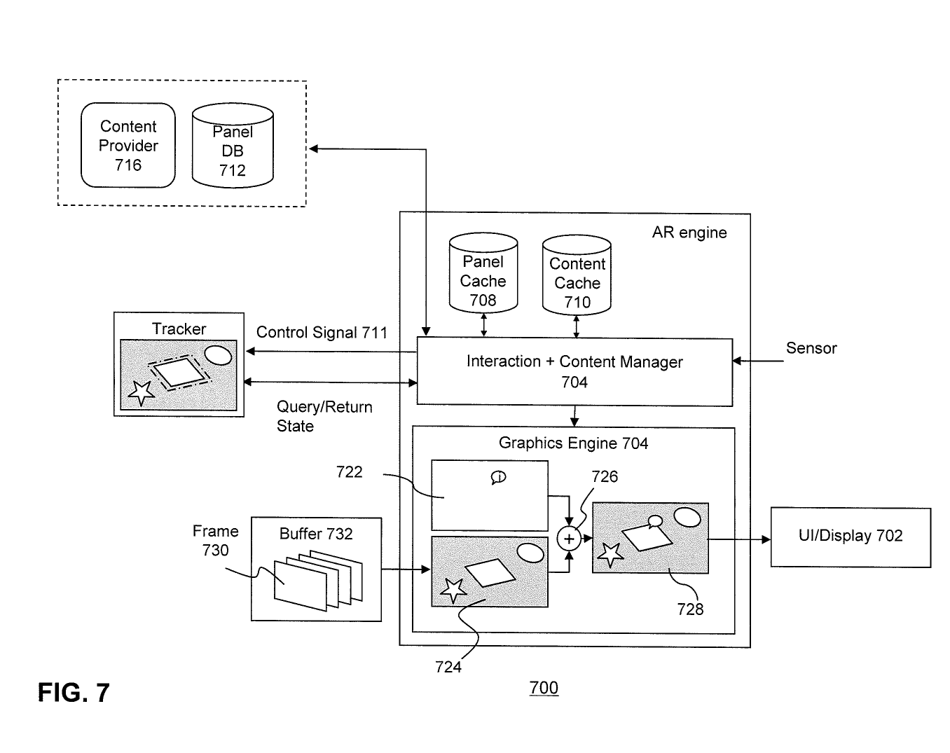

FIG. 7 depicts an AR engine 700 for use in a vision-based AR system according to one embodiment of the disclosure. AR engine may be configured to map a piece of content as a graphical overlay onto a tracked object, while the content will be transformed (i.e. translated, rotated, scaled) on the basis of 3D state information so that it matches the 3D pose of the tracked object. The graphical display 702 may be generated by graphics engine 704. The graphical display may be interactive, configured to react to and receive input from UI and/or sensors in the AR device. To manage the various processes in AR engine, interaction and content (IC) manager 706 may be configured to manage the inputs from external sources such as UI and/or sensors. AR engine may include cache memory to store panel information as well as content associated with a panel (panel cache 708 and content cache 710 respectively).

IC manager 706 may be further configured to transmit a control signal 711 to tracker to initiate tracking. The control signal may comprise one or more object IDs associated with one or more objects to be tracked.

IC manager may transmit the control signal in response to user input from as UI, such as a button press or a voice command, etc. IC manager may also transmit the control signal in response to sensor data from sensors. For instance, sensor data providing the geographical location of the AR client (such as entering/leaving a particular geographical region) may trigger IC manager to send the control signal. The logic for triggering of the transmission of the control signal may be based on at least one of: image frames, audio signal, sensor data, user input, internal state of AR client, or any other suitable signals.

In one instance, the triggering of object recognition (and subsequently triggering tracking) may be based on user input. For instance, a user using AR client may be operating in camera mode. The user may point the camera of the device, such as a mobile phone, towards an object that he/she is interested in. A button may be provided to the user on the touch-sensitive display of the device, and a user may press the button to snap a picture of the object of interest. The user may also circle or put a frame around the object using the touch-sensitive display to indicate an interest in the object seen through the camera view.

Based on these various user inputs, a control signal 711 may be transmitted to tracker such that tracking may begin. Conversely, a user may also explicitly provide user input to stop tracking, such as pressing a button to “clear screen” or “stop tracking”, for example. Alternatively, user input from UI to perform other actions with AR client may also indirectly trigger control signal to be sent. For instance, a user may “check-in” to a particular establishment such as a theater, and that “check-in” action may indirectly trigger the tracking process if it has been determined by IC manager that the particular establishment has an associated trackable object of interest (e.g., a movie poster).

In another instance, the triggering of tracking is based on the geographical location of the user. Sensor data from sensor may indicate to AR engine that a user is a particular longitude/latitude location. In yet another instance, tracking process may be initiated when a user decides to use the AR client in “tracking mode” where AR client may look for trackable objects substantially continuously or live as a user moves about the world with the camera pointing at the surroundings. If the “tracking mode” is available, control signal may be transmitted to tracker upon entering “tracking mode”. Likewise, when the user exits “tracking mode” (e.g., by pressing an exit or “X” button), control signal may be transmitted to tracker to stop tracking (e.g., to flush features cache).

After tracking process in tracker has been initiated with the control signal, tracker may begin to keep track of the 3D state information associated with the tracked object. At certain appropriate time (e.g., at periodic time intervals, depending on the device, up to about 30 times per second, at times when a frame is drawn, etc.), IC manager may query the tracker for 3D state information. IC manager may query the state from tracker periodically, depending on the how often the graphical user interface or AR application is refreshed. In some embodiments, as the user (or the trackable object) will almost always be moving, the state calculation and query may be done continuously while drawing each frame.

IC manager 706 may retrieve the panel data associated with the object ID. Depending on how the tracker was triggered, the content identified in the panel data for displaying on top of or associated with the tracked object. For example, IC manager 706 may obtain a panel from panel database 712 based on the identification information in the retrieved state data. Panel data may include at least one of: content layout information, user interactivity configuration information, instructions for fetching content as described above in detail with reference to FIG. 3.

The retrieved panel data may be stored in panel cache 710. Based on the instructions for fetching the content, IC manager 706 may communicate with content provider 716 to fetch content accordingly and store the fetched content in content cache. Based on the 3D state information and the information in the obtained panel, IC manager may instruct graphics engine 704 to generate in a first embodiment a graphical overlay 722.

In a first embodiment, in case of a non-interactive panel, the graphical overlay may comprise content which is scaled, translated and/or rotated on the basis of the 3D pose information (i.e., transformed content) so that it matches the 3D pose of the object tracked on the basis of the associated image frame 724 rendered by the imaging device.

In a second embodiment, in case of interactive panel, the graphical overlay may be regarded as a GUI comprising content and user-input receiving areas, which are both scaled, translated and/or rotated on the basis of the 3D pose information so that it matches the 3D pose of the object tracked on the basis of the associated image frame 724 rendered by the imaging device. This way the graphical overlay or the GUI is displayed in perspective with the tracked object in the scene. Because the GUI is rendered in perspective, in one embodiment, touch events may be transformed to coordinates in the GUI. For swiping and dragging behavior, this translation makes it possible for swiping in a direction relative to the GUI, instead of the physical screen.

The content layout information and user interactivity configuration information in the panel may determine the appearance and the type of GUI generated by the graphics engine. Once properly scaled, rotated and/or translated, the graphical overlay may be superimposed on the real life image (e.g., frame 730 from buffer 732 and graphical overlay 722 using graphics function 726 to create a composite/augmented reality image 728), which is subsequently displayed on display 702.

FIG. 8 depicts a system 800 for managing panels and tracking resources according to one embodiment of the disclosure. Modules for managing panels and tracking resources may include a panel publisher 802, a features generator 804, and fingerprint generator 806. Content provider, e.g., an entity interested in providing content in augmented reality, may use panel publisher to publish and check panels created by the content provider. Panel publisher may be a web portal or any suitable software application configured to allow content provider to (relatively easily) provide information about objects they would like to track and information for panels.

Examples of panel publisher may include a website where a user may use a web form to upload information to a server computer, and a executable software program running on a personal computer configured to receive (and transmit to a server) information in form fields.

In some embodiments, a content provider may provide at least one reference image or photo of the object to be tracked by the system. The reference image may be an image of a poster, or a plurality of images of a three-dimensional object taken from various perspectives. For that particular object, content provider may also provide sufficient information such that a proper panel may be formed. Example information for the panel may include code for a widget or a plug-in, code snippets for displaying a web page, SQL query suitable for retrieving content from the content provider (or some other server), values for certain parameters available for that panel (e.g., numeric value for size/position, HEX values for colors).

The Panel publisher may take the reference image(s) from content provider and provide them to the features generator for feature extraction. For each reference image, features may be extracted by feature extractor 806. Feature selector 808 may select a subset of the features most suitable for object recognition (i.e., recognizing the object of interest in a candidate image frame in the tracker of the AR client). The resulting selected features may be passed to the tracking resources database in the form of a feature package for each reference image. Details of an exemplary feature package are explained in relation to FIG. 8.

To facilitate initial object recognition (e.g., by object recognition system), the reference images may be provided to the fingerprint generator 110. Fingerprint generator may be configured to perform feature extraction such that the fingerprint generated substantially uniquely defines the features of the object. The generated fingerprints along with an association with a particular object (e.g., with object ID or other suitable identification data), transmitted from fingerprint generator for storage in fingerprint database, enables the object recognition system to identify objects based information provided by AR client. The generated fingerprints may be stored with an association to the corresponding object metadata, such as an object ID. The object metadata may include at least one of: object name, content provider name/ID, geographical location, type of object, group membership name/ID, keywords, tags, etc. The object metadata preferably facilitates object recognition system to search for the appropriate best match(es) based on information given by AR client (e.g., image frame, keywords, tags, sensor data, etc.). The search may be performed by search engine.

Once a desired panel has been checked for errors or validated, the panel is stored in panel database for future use. The panel itself or the panel data provided by content provider may be subsequently modified to fit the format used in panel database. The desired panel may be assigned an object ID for easier indexing. For instance, panel database may be configured to efficiently return a corresponding panel based on a request or query based on an object ID.

9A and 9B depict graphical user interfaces for use in a vision-based AR system according to various embodiments of the disclosure. In particular, FIG. 9A depicts a first GUI 902 and a related second GUI 904, wherein the GUI is rendered on the basis of interactive panel as described in detail in FIG. 1-8. The interactive panel allows the AR client to display the GUI in perspective with the tracked object, in this case a book.

In this particular example, a user sees a book on a table and captures an image of the book using a camera in the AR device. The AR client may then send that image to the object recognition system. If the book is one of the objects recognized by object recognition system, it may return the corresponding object ID of the book to AR client. The object ID enables AR client to retrieve the information needed for tracking and displaying the GUI.

Tracking in this exemplary embodiment involves periodically estimating the pose information of the object (the book). As the user moves around the real world with the AR device, tracking enables AR client to have an estimate on the position and orientation of the trackable object in 3D space. In particular, that information enables the generation of computer graphics that would appear to the user to be physically related or associated with the tracked object (e.g., adjacent, next to, on top of, around, etc.). Even if the user or the object moves around and the trackable object appears in a different position on display, tracking enables AR client to continue to “follow” or guess where the object is by running the tracking algorithm routine.

Once tracking resources are retrieved using the object ID of the book seen in display, tracker estimates the 3D pose information and provides it to AR engine so that the GUI may be generated. AR engine also retrieves and receives the corresponding panel to the book using the object ID.

The first GUI depicted in FIG. 9A is presented to the user in perspective with the object and may comprise first and second input areas 905,906 which are configured to receive user input. First and second input areas may be defined on the basis of the user interactivity configuration information defined in the panel. In this example, first input area may be defined as a touch-sensitive link for opening a web page of a content provider. Similarly, second input area may be defined as a touch-sensitive area for executing a predetermined content-processing API, in this example referred to the “image carrousel”.

When selecting the second input area, an content rendering API may be executed which is used to generate a second GUI 904. The API may start a content rendering process wherein one or more further content files are requested from a content provider, wherein the content files comprise content which is related to the tracked object. Hence, in this example, the API will request one or more content files comprising covers of the tracked book 911 and covers of books 910,912 on the same or similar subject-matter as the tracked book. The API may linearly arrange the thus retrieved content and on the basis of the 3D state information, the AR may display thus arranged content as a graphical overlay over the tracked object. Moreover, also in this case, the graphic overlay may be configured as second GUI (related to the first GUI) comprising input areas defined as touch-sensitive buttons 913,915 for opening a web page of a content provider or for returning to the first GUI.

FIG. 9B depicts the functionality of the second GUI 904 in more detail. In particular, FIG. 9B illustrates that the GUI is further configured to receive gesture-type user input. When a user touches a content item outside the touch-sensitive areas and makes a swiping gesture in a direction parallel to the linearly arranged content items (in this case book covers), a content item may linearly translate along an axis of the tracked object. When applying the swiping gesture 917, the GUI will linearly translate the content items such that a next content item will be arranged on the tracked object as shown in 916. This may be regarded as a second state of the GUI. By repeating the swiping gestures, a user may browse through the different states of the GUI thereby displaying the content items which are related to the tracked object.

The second state of the GUI may also comprise a further touch-sensitive area 918 for receiving user input. When selected, a web page 920 of a content provider associated with the content item may be opened.

Hence, the carousel may enable a user to swipe through and rotate the image carousel to see more related books. A user can provide a gesture to indicate that he/she would like to rotate the carousel to see other books related to the book on the table. In response to receiving that gesture, AR engine (e.g., interaction and content manager) may dynamically fetch for more content in accordance with the panel corresponding to the book, and generate new computer generated graphics to be displayed in perspective with the book.

Hereunder a simplified representation in pseudo-code of an interactive panel API is provided. In this particular example, the interactive panel AIP is configured for generating and controlling a GUI associated with tracked objects as described with reference to FIGS. 9A and 9B. This example illustrates how an online book store may simply create a panel for displaying information about a book and related items in a flexible and interactive way.

The panel instance may be created for a specific book identified by its ISBN number. The panel itself contains instructions for fetching the information from the Content Provider (i.e. APIs provided by the bookstore itself). The panel definition may look as follows:

```
{
  panel_definition_id: 321,
  panel_developer: bookstore,
  template_url: http://bookstore.com/panel_template.html
  attributes: [
    {
      type: string,
      name: ISBN
    }
  ]
}
```

The panel template containing references to multiple files may be provided in the form of an HTML page including a linked JavaScript file for handling interaction and calls to the content provider. The HTML page may also contain an CSS file for defining the styles and positioning of elements used in the HTML. The latter is omitted in this example, and both the HTML and JavaScript are provided in a simplified pseudo-code form.

```
panel_template.html:
<html>
  <head>
    <script type=“text/javascript”
src=“http://bookstore.com/panel_template.js”/>
  </head>
  <body>
    <div id=“book_info”>
      <p class=“price”/>
      <input type=“button” class=“info_button”/>
      <input type=“button” class=“related_items_button”/>
    </div>
    <!-- Template for showing multiple related items -->
    <div style=“hidden” id=“related_book_info”>
      <img id=“cover”/>
      <p class=“price”/>
      <input type=“button” class=“info_button”/>
      <input type=“button” class=“close_button”/>
    </div>
  </body>
</html>
```

The javascript file associated with the panel template may look as follows:

```
panel_template.js:
// internal variable for the data fetched from the content
provider
var isbn;
var book_info;
var related_book_info[ ];
function setAttributes(attributes) {
  isbn = attributes.isbn;
  book_info = fetch_book_info(isbn);
  // update the HTML to show the price information of the book
  $(“#book_info price”).setValue(book_info.price);
}
function fetch_book_info(isbn) {
  // call to the content provider to fetch the information
  // about the book. This may be implemented as an HTTP API
  // that returns JSON or XML data containing the price and a
  // link to the a webpage with more details
}
function fetch_related_book_info(isbn) {
  // call to the content provider to fetch the information
  // about related books. This may be implemented as an HTTP
  // API that returns JSON or XML data containing the price and
  // a link to the a webpage with more details for all related
  books.
}
$(“document”).ready(function( ) {
  // setup related items button behavior
  $(“book_info related_items_button”).click(function( ) {
    // fetch the data from the content provider
    related_book_info = fetch_related_book_info(isbn);
    // hide the current book information
    $(“book_info”).hide( );
    // create HTML content from the template for each related
    // book and add them to the document (positioning is
    // omitted in this example, but can be handled easily using
    css styles).
    for (int i=0; i<related_book_info.length; i++) {
      var book_snipped = $(“related_book_info”).copy( );
      $(book_snipped).price = related book_info[i].price;
      $(book_snipped).cover = related_book_info[i].cover;
      $(“document”).add(book_snipped);
    }
    $(“related_book_info”).show( );
  });
  // setup related items close button behavior
  $(“related_book_info close_button”).click(function( ) {
      // hide the related books, and show the original book info
      $(“related_book_info”).hide( );
      $(“book_info”).show( );
  });
  $(“info_button”).click(function( ) {
    // leave the AR view and open an web view containing the
// page for the book, including “buy now” button.
  });
  $(“related_book_info cover”).click(function( ) {
    // when clicking the cover of a related book, we slide it
    // into view towards the center of the book that is being
    // tracked. This can be handled using CSS transformations.
  });
});
```

As seen in the previous example, panel instances can be created using this panel definition in the following way.

```
{
  panel_id: 654,
  panel_definition_id: 321,
  attribute_values: {
    isbn: 978-0321335739
  },
  placement: {
    object_id: 987,
    offset: {
      x: 0, y: 0, z: 0
    },
    angle: 0,
  }
}
```

Note that in the above example, the object_id is an internal object identifier. For a system that only deals with books, this may also be the isbn number of the book that should contain the panel.

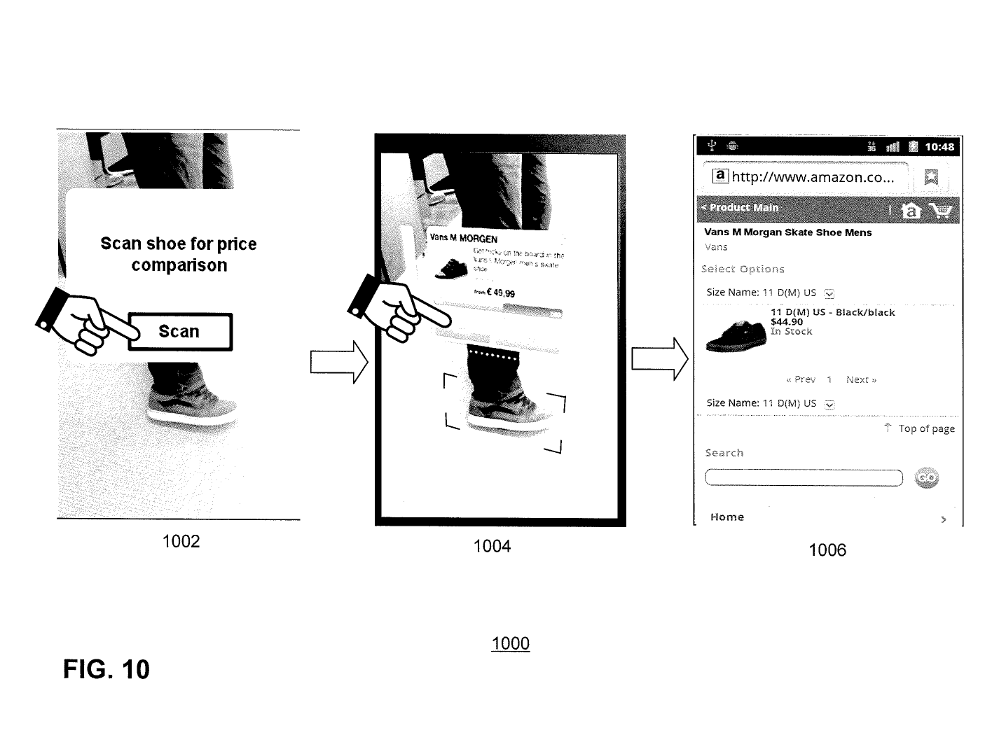

FIG. 10 depicts related graphical user interfaces 1002, 1004, 1006 for use in a vision-based AR system according to other embodiments of the disclosure. In this case, an online retailer may have provided a panel associated with the shoe, where the panel includes instructions and content layout for generating a GUI for displaying information (text, price, and other features) on a particular item (e.g. a shoe).

In a first step, a GUI 1002 may ask a user to take a picture of the show and send it to the object recognition system. Once the shoe has been recognized, the appropriate tracking resources and panel may be retrieved for the shoe. On the basis of tracking resources and the panel, an GUI as depicted in 1004 may be rendered and provided to the user.

Based on the 3D state information provided by the tracker, content layout and instructions for fetching content in the panel, AR engine may provide the interactive graphical user interface to appear substantially in perspective with the shoe (even when the user is moving about the real world and changing the pointing direction of the augmented reality device).

The user interactivity configuration of the interactive graphical user interface may be integrated with the HTML and CSS code. For instance, an interactive button “Buy Now” may be programmed as part of the HTML and CSS code. The online retailer may specify a URL for the link such that when a user presses on the button “Buy Now”, the user would be directed to display 1006, where he/she is brought to the online retailer's website to purchase the shoe.

In some embodiments, a related GUI may display, on top of the tracked shoe, a computer generated picture of the shoe in different colors and variations, allowing the user to explore how the shoe may look differently if the color, markings, or designs have changed. In certain embodiments, an video, animated graphic, advertisement, audio, or any suitable multimedia may be displayed and provided to the user through the interactive graphical user interface.

Optionally, tick marks may be generated and displayed in perspective with the tracked object to indicate that the shoe is being tracked by AR engine. In some other embodiments, the perimeter or outline of the object may be highlighted in a noticeable color. In certain embodiments, an arrow or indicator may be generated and displayed to point at the tracked object.

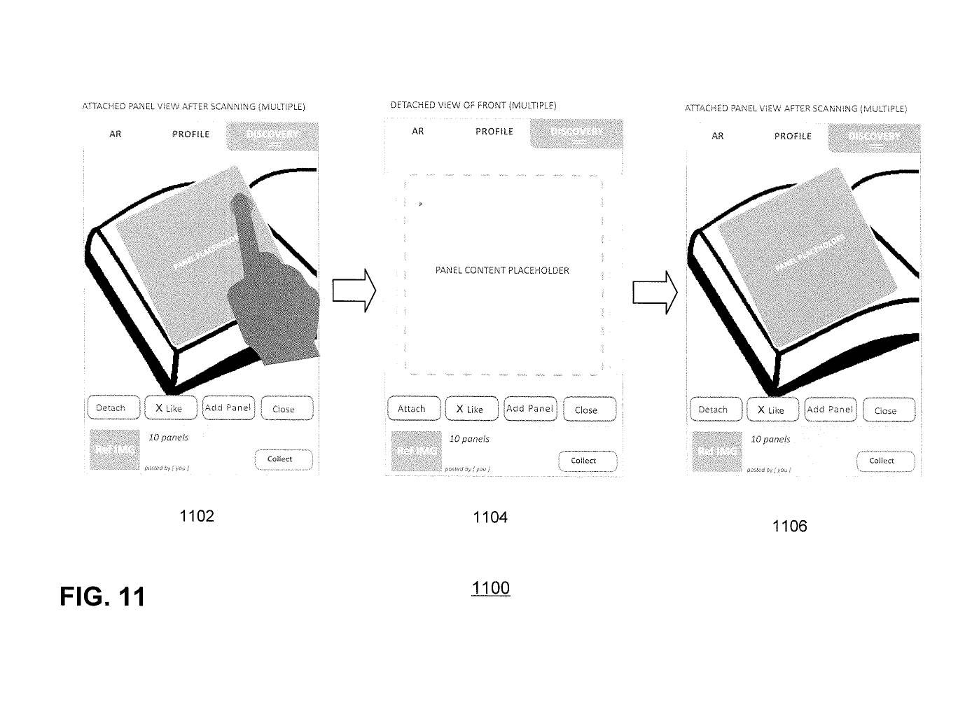

FIG. 11 depicts graphical user interfaces for use in a vision-based AR system according to yet other embodiments of the disclosure. In particular related GUIs 1102,1104,1106 illustrate a function to detach a content item (or a GUI) from the tracked object, to display the detached content item (or GUI) in alignment with the display and to (re)attach the content (or GUI) item with the tracked object.

A detach functionality may be provided for the graphical user interface of the panel if desired. Sometimes, when tracking an image, the user has to hold his phone in an uncomfortable position (e.g. when looking at a billboard on a building). Accordingly the user is provided with an option on the graphical user interface of the panel to detach the panel from the tracked object, so that the user can look away from the actual object, while still being able to see and interact with the panel.

When rendering augmented content in detached mode, an alternative model view matrix is used. Instead of using the estimated transformation (rotation and translation) parameters (associated with a first model view matrix H), a second (fixed) model view matrix H′ is used only containing a translation component to have the augmented content visible at a fixed distance behind the camera.

For an improved user experience, the switching between detached mode associated with the first matrix H (as shown by GUI's 1102 and 1106) and a non-detached mode associated with second matrix H′ (as shown by GUI 1104) may be smoothed out by generating a number of intermediate module view matrices. These matrices may be determined by interpolating between the estimated model view matrix and the detached model view matrix. The smoothing effect is generated by displaying a content item on the basis of the sequence of model view matrices within a given time interval.

A GUI may include a pointing direction, which is typically pointing in the same direction as the tracked object, if the interactive graphical user interface is displayed in perspective with the tracked object. When the GUI is displayed out of perspective, it is preferably generated and displayed to the user, with a pointing direction towards the user (and aligned with the display) using the augmented reality device. For example, to unpin/detach the GUI, the interactive graphical user interface may be animated to appear to come towards the user such that it can be displayed out of perspective with the tracked object. The interactive graphical user interface may appear to move towards the user, following a path from the position of the tracked object to a position of the display.

While tracking, the tracker may maintain a rotation matrix, which contains the rotation and translation of the object relative to the camera (e.g., camera of the AR device). For the detached mode, in some embodiments, AR client may render everything in 3D context.

Once an interactive graphical user interface is generated and displayed in perspective with the tracked object (GUI 1102), a user may unpin or detach the GUI from the tracked object. A user may provide user input to unpin or detach the GUI resulting in a detached GUI 1104. User input may be received from the UI or sensor, and said use input may include a motion gesture, hand gesture, button press, voice command, etc. In one example, a user may press an icon that looks like a pin, to unpin the GUI. To pin or attach the panel back to the tracked object, a user may similarly provide user input (e.g., such as pressing a pin icon) and the GUI may then be animated to flow back to the tracked object and appear in perspective with the tracked object (GUI 1106).

In some embodiments, content items are displayed as a two dimensional content item in perspective with the tracked object. Such 2D content item may be regarded as a “sheet” having a front side and a back side. Hence, when requiring the display of more content to the user without expanding the real estate or size of a content item, in some embodiments, a GUI may be configured comprising icon or button allowing the user to “flip” the content item or user interface from the front to its back (and vice versa). In this manner, the “back” or other side of the graphical overlay may be shown to the user, which may comprise other information/content that may be associated with the tracked object or the graphical user interface itself.

In one embodiment, upon receiving user input to flip the graphical user interface of the panel, the graphical layer making up the graphical user interface may be scaled, transformed, rotated and possibly repositioned such that flipping of the graphical user interface is visually animated and rendered for display to the user. In other words, frames of the graphical layer making up the graphical user interface for display are generated by transforming the graphical layer for successive frames such that the graphical user interface appears visually to be flipping from one side to another.

The flipping effect may be implemented by adding an additional rotation component to the estimated camera model view matrix P. This rotation is done around the origin point of the content item, giving the effect that it flips.

In one example, if the graphical user interface is displayed in perspective with a tracked object and an indication to “flip” the graphical user interface is received (e.g., via a button on the graphical user interface or a gesture), the graphical user interface may be animated to flip over. The end result of the animation may display a “back side” of the graphical user interface in perspective with the tracked object. If needed, IC manager may query panel store or content store for the content to be displayed and rendered on the “back side” of the graphical user interface. In another example, if the graphical user interface is displayed out of perspective and a user indication to “flip” the graphical user interface is received, a similar process may occur, but with the end result of the animation displaying the “back side” of the graphical user interface still out of perspective with the tracked object.

In one embodiment, the graphical user interface has a first pose (i.e., position and orientation) within the augmented reality space. Upon receiving the user indication to flip the graphical user interface, a flipping animation causes the graphical user interface to rotate around one of the axes lying in the plane of the graphical user interface for 180 degrees from a the first pose to a second pose at the end of the flipping animation. The graphical user interface may become a two-sided object in the three-dimensional augmented reality space. Accordingly, the content for the “back-side” of the graphical user interface may be obtained based on the instructions for fetching content in the panel corresponding to the graphical user interface (in some cases the content is pre-fetched when the panel is first used).

To form the two-sided object, another non-transformed graphical layer for the graphical user interface using the back-side content may be composed with the front-side content (i.e., the original non-transformed graphical layer). Using the graphical layer of the back-side and the front-side, a two-sided object having the original non-transformed graphical layer on front side and the other non-transformed graphical layer on the back side may be created. Using any suitable three-dimensional graphics algorithms, an animated sequence of graphical layers may be generated by scaling, rotating and translating the two-sided object such that the graphical layer appears to flip in orientation (e.g., rotate the object in three-dimensional space from one side to an opposite side) resulting in a second pose of the graphical user interface being substantially 180 degrees different in orientation from the first pose. As such, the size of the panel object has not been increased or taken up more real estate of the display screen, and yet more content may be provided to the user via the graphical user interface. Understood by one skilled in the art, the back-side of the graphical user interface may also be configured through the data structure of a panel as described herein.

One embodiment of the disclosure may be implemented as a program product for use with a computer system. The program(s) of the program product define functions of the embodiments (including the methods described herein) and can be contained on a variety of computer-readable storage media. The computer-readable storage media can be a non-transitory storage medium. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory, flash memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

1. A method for generating an augmented reality content item on a user device comprising a digital imaging part, a display output, a user input part and an augmented reality client, said client comprising a computer-vision based tracker for tracking an object in said display on the basis of at least an image of the object from the digital imaging part, said method comprising:
receiving an object identifier associated with an object in an image;
on the basis of said object identifier retrieving panel data from a panel database and tracking resources from a tracking resources database, said panel data comprising at least location information for retrieving a content item;
on the basis of said tracking resources said computer-vision based tracker generating three-dimensional pose information associated with said object;
on the basis of said panel data requesting at least part of said content item; and,
on the basis of said three-dimensional pose information rendering said content item for display in the display output such that the content rendered matches the three-dimensional pose of said object in the display output.

2. A method for generating an augmented reality graphical user interface on a user device comprising a digital imaging part, a display output, a user input part and an augmented reality client, said client comprising a computer-vision based tracker for tracking an object in said display on the basis of at least an image of the object from the digital imaging part, said method comprising:
receiving an object identifier associated with an object in an image;
on the basis of said object identifier retrieving panel data from a panel database and tracking resources from a tracking resources database, said panel data comprising at least location information for retrieving a content item and user interactivity configuration information, said content item and said user interactivity information defining a graphical user interface;
on the basis of said tracking resources said computer-vision based tracker generating three-dimensional pose information associated with said object;
on the basis of said panel data, requesting at least part of said content item; and,
on the basis of said user interactivity configuration information and said three-dimensional pose information, rendering said graphical user interface for display in the display output such that the graphical user interface rendered matches the three-dimensional pose of said object in the display output.

3. The method according to claim 1, further comprising:
receiving an image frame from a digital imaging device of the augmented reality system;
transmitting the image frame to an object recognition system;
receiving, in response to transmitting the image frame, identification information for the tracked object from an object recognition system if the transmitted image frame matches the tracked object; and
storing the identification information for the tracked object as state data in the tracker.

4. The method according to claim 1, further comprising:
receiving, at the tracker, an image frame from a camera of the augmented reality system;
estimating, in the tracker, the three-dimensional pose of the tracked object from at least the image frame; and
storing the estimated three-dimensional pose of the tracked object as state data in the tracker.

5. The method according to claim 4, wherein estimating the three-dimensional pose of the tracked object from at least the image frame comprises:
obtaining reference features from a reference features database based on the identification information in the state data;
extracting candidate features from the image frame;
searching for a match between the candidate features and reference features, said reference features associated with the tracked object in the image frame;
estimating a two-dimensional translation of the tracked object in the image frame in response to a finding a match from searching for the match between candidate and reference features;
estimating a three-dimensional pose of the tracked object in the image frame based at least in part on the camera parameters and the estimated two-dimensional translation of the tracked object.

6. The method according to claim 1, wherein said three-dimensional pose information is generated using homogeneous transformation matrix H and a homogeneous camera projection matrix P, said homogeneous transformation matrix H comprising rotation and translation information associated with the camera relative to the object and said homogeneous camera projection matrix defining the relation between the coordinates associated with the three-dimensional world and the two-dimensional image coordinates.

7. The method according to claim 2, wherein content layout data comprises visual attributes for elements of the graphical user interface.

8. The method according to claim 2, wherein the user interactivity configuration data comprises at least one user input event variable and at least one function defining an action to be performed responsive to a value of the user input event variable.

9. The method according to any claim 2, further comprising:
receiving a first user input interacting with the graphical user interface;
retrieving a further content item on the basis of said location information in said panel data, said further content item and said user interactivity configuration information defining a further graphical user interface;
on the basis of said user interactivity configuration information and said three-dimensional pose information, rendering said further graphical user interface for display in the display output such that the graphical user interface rendered matches the three-dimensional pose of said object in the display output.

10. The method according to claim 2, wherein said three-dimensional pose information is generated using a homogeneous transformation matrix H, said homogeneous transformation matrix H comprising rotation and translation information of the camera relative to the object, said method further comprising:
receiving a first user input interacting with said graphical user interface for generating a further graphical user interface;
providing a further a second homogeneous transformation matrix H′ only comprising a static translation component;
generating further three-dimensional pose information on the bases of said homogeneous transformation matrix H′;
on the basis of said user interactivity configuration information and said further three-dimensional pose information, rendering said further graphical user interface for display in the display output such that said further graphical user interface rendered is detached from the three-dimensional pose of said object in the display output and positioned at a fixed distance behind the camera.

11. The method according to claim 2, wherein said panel data further comprise:
content layout information for specifying the display of a subset of content items from a plurality of content items in a predetermined spatial arrangement;
user interactivity configuration information comprises a function for displaying a next subset of content items from said plurality of images in response to receiving a first user input interacting; and
location information comprising instructions for fetching at least one additional content items of said next subset of content items from a location,
said method further comprising:
on the basis of said content layout information, said user interactivity configuration information, said location information and said three-dimensional pose information, rendering a further graphical user interface for display in the display output such that said further graphical user interface rendered matches the three-dimensional pose of said object in the display output.

12. The method according to claim 1, wherein said panel data further comprise:
the user interactivity configuration information comprises a function for displaying at least part of the backside of an augmented reality content item or an augmented reality graphical user interface in response to receiving a first user input interacting;
location information comprising instructions for fetching a further content item and/or a further graphical user interface associated with the backside of said augmented reality content item or said augmented reality graphical user interface;
said method further comprising:
on the basis of said content layout information, said user interactivity configuration information, said location information and said three-dimensional pose information, rendering a further graphical user interface for display in the display output such that said further graphical user interface rendered matches the three-dimensional pose of said object in the display output.

13. The method according to any claim 12, wherein said panel database and said tracking resources database are hosted on one or more servers, and wherein said augmented reality client is configured to communicate with said one or more servers.

14. A client for generating an augmented reality content item on a user device comprising a digital imaging part, a display output, a user input part, said client comprising a computer-vision based tracker for tracking an object in said display on the basis of at least an image of the object from the digital imaging part, said being configured for:
receiving an object identifier associated with an object in an image;
on the basis of said object identifier retrieving panel data from a panel database and tracking resources from a tracking resources database, said panel data comprising at least location information for retrieving a content item;
on the basis of said tracking resources said computer-vision based tracker generating three-dimensional pose information associated with said object;
on the basis of said panel data requesting at least part of said content item; and,
on the basis of said three-dimensional pose information rendering said content item for display in the display output such that the content rendered matches the three-dimensional pose of said object in the display output.

15. A client for generating an augmented reality graphical user interface on a user device comprising a digital imaging part, a display output, a user input part, said client comprising a computer-vision based tracker for tracking an object in said display on the basis of at least an image of the object from the digital imaging part, said client further being configured for:
receiving an object identifier associated with an object in an image;
on the basis of said object identifier retrieving panel data from a panel database and tracking resources from a tracking resources database, said panel data comprising at least location information for retrieving a content item and user interactivity configuration information, said content item and said user interactivity information defining a graphical user interface;
on the basis of said tracking resources said computer-vision based tracker generating three-dimensional pose information associated with said object;
on the basis of said panel data, requesting at least part of said content item; and,
on the basis of said user interactivity configuration information and said three-dimensional pose information, rendering said graphical user interface for display in the display output such that the graphical user interface rendered matches the three-dimensional pose of said object in the display output.

16. A user device comprising a client according to claim 14.

17. A vision-based augmented reality system comprising:
one or more servers configured to host a panel database, a tracking resources database and a object recognition system; and
a user device configured communicatively connect to said one or more servers and to generate an augmented reality content item comprising a digital imaging part, a display output, a user input part said client comprising a computer-vision based tracker for tracking an object in said display on the basis of at least an image of the object from the digital imaging part, said being configured for:
receiving an object identifier associated with an object in an image;
on the basis said object identifier retrieving panel data from a panel database and tracking resources from a tracking resources database, said panel data comprising at least location information for retrieving a content item;
on the basis of said tracking resources said computer-vision based tracker generating three-dimensional pose information associated with said object;
on the basis of said panel data requesting at least part of said content item; and,
on the basis of said three-dimensional pose information rendering said content item for display in the display output such that the content rendered matches the three-dimensional pose of said object in the display output.

18. A graphical user interface for a user device comprising a digital imaging part, a display output, a user input part and an augmented reality client, said graphical user interface being associated with a object displayed in said display output;
said graphical user interface being rendered on the basis of panel data from a panel database and three-dimensional pose information associated with said object, said panel data comprising at least location information for retrieving a content item,
wherein said graphical user interface comprises said content item and at least one user input area, wherein said content item and said at least one user input area match the three-dimensional pose of said object.

19. A data structure stored in a storage medium, said data structure controlling the generation of a graphical user interface in a user device, said data structure comprising: content layout information for specifying the display of a content item in said graphical user interface, user interactivity configuration information for configuring one or more user-input functions used by said graphical user interface and location information comprising instructions for fetching a content item from a content source.

20. A computer program product, implemented on computer-readable non-transitory storage medium, the computer program product configured for, when run on a computer, generating an augmented reality content item on a user device comprising a digital imaging part, a display output, a user input part and an augmented reality client, said client comprising a computer-vision based tracker for tracking an object in said display on the basis of at least an image of the object from the digital imaging part, said method comprising:
receiving an object identifier associated with an object in an image;
on the basis of said object identifier retrieving panel data from a panel database and tracking resources from a tracking resources database, said panel data comprising at least location information for retrieving a content item;
on the basis of said tracking resources said computer-vision based tracker generating three-dimensional pose information associated with said object;
on the basis of said panel data requesting at least part of said content item; and,
on the basis of said three-dimensional pose information rendering said content item for display in the display output such that the content rendered matches the three-dimensional pose of said object in the display output.
